(19) United States
(12) Patent Application Publication
(10) Pub. No.: US 2026/0227728 A1
(43) Pub. Date: Aug. 6, 2026

(54) IMAGE FORMING APPARATUS

(71) Applicant: CANON KABUSHIKI KAISHA, Tokyo (JP)

(72) Inventor: ATSUSHI IWASAKI, Shizuoka (JP)

(21) Appl. No.: 19/430,523

(22) Filed: Dec. 23, 2025

(30) Foreign Application Priority Data
Feb. 6, 2025 (JP) 2025-018719

(51) Int. Cl. G03G 15/20; G03G 15/00; G03G 21/16

(52) U.S. Cl. CPC G03G 15/2035; G03G 15/55; G03G 15/657; G03G 21/1633; G03G 21/1647; G03G 15/2064; G03G 2215/00413; G03G 2215/00548; G03G 2215/00734; G03G 2221/1639; G03G 2221/1654; G03G 2221/1675

(57) ABSTRACT

An image forming apparatus includes a main assembly, a fixing unit accommodated in the main assembly, a connector for connecting the main assembly and the fixing unit, and an open/close member provided to the main assembly. The fixing unit is movable between a first position of the fixing unit in a closed state of the open/close member and where a fixing operation is performed, and a second position in an open state of the open/close member and where the fixing unit is moved from the first position by the connector which is urged, and includes a restraint member for restraining the fixing unit to the second position. A force necessary for moving the fixing unit restrained in the second position toward the first position is larger than a force necessary for pulling the recording material being nipped out of a nip to an upstream side in a conveyance direction.

### BACKGROUND

### Field of the Technology

The present invention relates to an image forming apparatus that forms an image on a recording material.

### Description of the Related Art

Some image forming apparatuses, such as printers, copiers, and multifunction printers, have cartridges dismountably mounted on a tray that moves between the inside and outside of a main assembly. For example, Japanese Laid-Open Patent Application (JP-A) 2010-244018 discloses an image forming apparatus that includes a tray to which a cartridge is dismountably mounted, and a fixing unit. The tray is movable to the outside of the main assembly of the image forming apparatus through a plurality of openings. Further, for example, Japanese Laid-Open Patent Application (JP-A) 2015-206897, discloses an image forming apparatus that includes a tray to which a cartridge is dismountably mounted, a transfer unit, and a fixing unit. In Japanese Laid-Open Patent Application (JP-A) 2015-206897, a tray and a transfer unit are movable from the inside to the outside of the image forming apparatus. Specifically, the fixing unit is disposed at one end side of the main assembly of the image forming apparatus, and when the transfer unit moves to the outside of the main assembly, the transfer unit moves in a direction from an other end side of the main assembly toward the one end side. On the other hand, when the tray moves to the outside of the main assembly, the tray moves in a direction from the one end side toward the other end side of the main assembly. Furthermore, for example, Japanese Laid-Open Patent Application (JP-A) 2024-041715 discloses that when the tray on which a cartridge is dismountably mounted and the transfer unit are moved from the inside to the outside of the image forming apparatus, the fixing unit connected to the image forming apparatus by an arm member is moved from a reference position to a retracted position. This allows the tray and the transfer unit to be movable in the same direction.

However, in a configuration in which the tray and the transfer unit are movable in the same direction, the following problem arises when performing a process to remove a recording material that has been nipped in the fixing unit due to a paper jam or the like. Incidentally, in the following description, the process of removing the recording material that has been nipped in the fixing unit due to a paper jam or the like is referred to as jam processing. During jam processing, the arm member operates by an urging force of a spring or the like, thereby causing the jam processing performance to deteriorate in a state in which the fixing unit is moved from the reference position to the retracted position. For example, when removing the recording material by pulling it toward an upstream side in a conveyance direction, which is the same direction as the direction in which the fixing unit returns to the reference position, a force for pulling the recording material may cause the fixing unit to move to the reference position side, making it difficult to remove the recording material.

### SUMMARY

The present invention was made under such a situation, and its purpose is to improve the jam processing performance when the recording material nipped in the fixing unit in the retracted position is pulled toward the upstream side in the conveyance direction to perform jam processing.

In order to solve the above-mentioned problems, the present invention has the following configuration. An image forming apparatus for forming an image on a recording material, the image forming apparatus comprising: a main assembly; a fixing unit accommodated in the main assembly and configured to perform a fixing process to a toner image formed on the recording material while nipping and conveying the recording material at a nip portion; a connecting member configured to connect the main assembly and the fixing unit; an urging member configured to urge the connecting member and operate the connecting member; and an open/close member openably/closably provided to the main assembly so as to be in an open state in which the fixing unit is exposed as seen from an outside of the main assembly and in a closed state in which the fixing unit is hidden as seen from the outside of the main assembly, wherein the fixing unit is movable between a first position which is a position of the fixing unit when the open/close member is in the closed state and where the fixing process is performed, and a second position which is a position of the fixing unit when the open/close member is in the open state and where the fixing unit is moved from the first position by an operation of the connecting member caused by the urging member, and includes a restraint member configured to restrain the fixing unit to the second position, and wherein a force necessary for moving the fixing unit, which is in the second position restrained by the restraint member, toward the first position is larger than a force necessary for pulling the recording material, which is in a state of being nipped in the nip portion of the fixing unit, out of the nip portion to an upstream side in a conveyance direction of the recording material.

Further features of the present disclosure will become apparent from the following description of exemplary embodiments with reference to the attached drawings.

### BRIEF DESCRIPTION OF THE DRAWINGS

FIG. 1 is a cross-sectional schematic view showing a configuration of an image forming apparatus according to embodiments 1 and 2.

FIG. 2 is a cross-sectional schematic view showing a state in which a door in embodiments 1 and 2 is open.

FIG. 3 is a cross-sectional schematic view showing a state in which a fixing unit in embodiments 1 and 2 has moved to a retracted position.

FIG. 4 is a cross-sectional schematic view showing a state in which a tray unit in embodiments 1 and 2 is moved.

Parts (a), (b), and (c) of FIG. 5 are schematic perspective views showing a supporting configuration and a lift-up configuration of the fixing unit in embodiment 1.

Parts (a) and (b) of FIG. 6 are schematic views showing a configuration and an action of a catch mechanism in embodiment 1.

FIG. 7 is a schematic perspective view illustrating jam processing in the retracted position of the fixing unit in embodiment 1.

Parts (a) and (b) of FIG. 8 are schematic views showing a modification of the catch mechanism in embodiment 1.

Parts (a), (b), and (c) of FIG. 9 are schematic views showing a latch mechanism according to embodiment 1.

Parts (a), (b), and (c) of FIG. 10 are schematic views showing a modification of the latch mechanism of embodiment 1.

FIG. 11 is a flow chart showing jam processing in embodiment 2.

Part (a) of FIG. 12 is a flow chart, and parts (b) and (c) of FIG. 12 are schematic views illustrating a process flow A in embodiment 2.

Parts (a) of FIG. 13 is a flow chart, and part (b) is a schematic view illustrating a process flow B of jam processing in embodiment 2.

Parts (a) of FIG. 14 is a flow chart, and part (b) is a schematic view illustrating a process flow C of jam processing in embodiment 2.

### DESCRIPTION OF THE EMBODIMENTS

### Embodiment 1

### Printer configuration

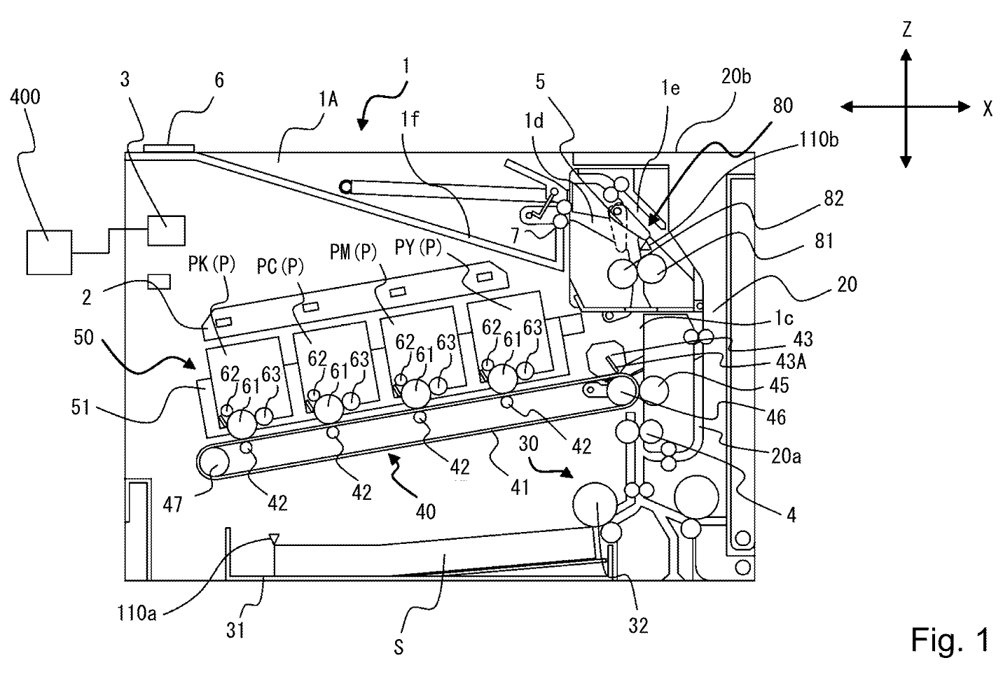

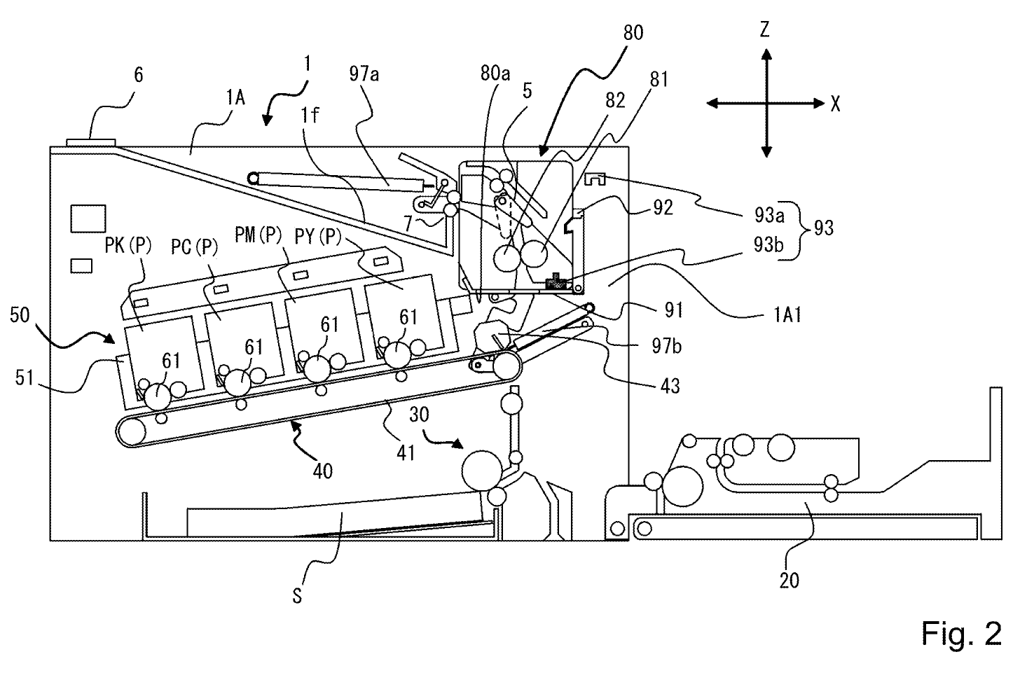

A printer 1 as an image forming apparatus will be described with reference to FIG. 1. FIG. 1 is a diagram illustrating an overall configuration of the printer 1 according to embodiment 1. The printer 1 is an electrophotographic color laser beam printer that forms an image on a sheet S as a recording material. The printer 1 includes a casing 1A, a scanner 2 (exposure device), a control unit 3, and a door 20 (open/close member) openably/closably provided with respect to the casing 1A. The door 20 is openably/closably provided in the casing 1A so as to be movable between a closed position in which the door 20 covers an opening 1A1 (see FIG. 2) and an open position in which the door 20 exposes the opening 1A1. FIG. 1 shows a closed state in which the door 20 closes the inside of the casing 1A, and FIG. 2 shows an open state in which the door 20 exposes the inside of the casing 1A. Furthermore, the printer 1 includes a sheet feeding unit 30, a transfer unit 40, a tray unit 50 (a moving unit, a supporting unit, and a cartridge) which is an image forming portion, and a fixing unit 80.

The casing 1A accommodates the scanner 2, the control unit 3, the sheet feeding unit 30, the transfer unit 40, the tray unit 50, and the fixing unit 80. Further, the casing 1A is provided with an operation panel 6. The sheet feeding unit 30 includes a stacking tray 31 for stacking sheets S and a paper feed roller 32. The stacking tray 31 can be pulled out toward the door 20 and replenished with sheets S.

The tray unit 50 includes a tray 51 (supporting member, drawer) and cartridges PY, PM, PC, and PK that are dismountably mounted on the tray 51. The cartridges PY, PM, PC, and PK are independently detachable from the tray 51. The cartridges PY, PM, PC, and PK accommodate yellow (Y), magenta (M), cyan (C), and black (K) toner (developers), respectively. The cartridges PY, PM, PC, and PK have the same configuration except that they accommodate different colors of toner. Therefore, the configuration and operation of one of the cartridges PY, PM, PC, and PK will be described, and descriptions of the other cartridges will be omitted. Further, the cartridges PY, PM, PC, and PK may be simply referred to as cartridges P when there is no need to distinguish between them. The tray unit 50 includes a plurality of cartridges P and the tray 51 on which the plurality of cartridges P are dismountably mounted. The tray unit 50 includes a photosensitive drum 61 (image bearing member), a charging roller 62 (charging member), and a developing roller 63 (developer carrying member) for each of the four cartridges. Rotational axis directions of the photosensitive drums 61, the developing rollers 63, and the charging rollers 62 are parallel to one another. Incidentally, as shown in FIG. 1, a vertical direction is a Z direction, and a direction perpendicular to the rotational axis direction of the photosensitive drums 61 and each roller and the Z direction is an X direction. The X direction is also a front-back direction when the door 20 is viewed from the front.

The transfer unit 40 includes a belt 41, a primary transfer roller 42, a cleaning portion 43, a driving roller 46 that drives the belt 41, and a tension roller 47 (driven roller). The belt 41 is disposed below the photosensitive drums 61, and the belt 41 can be brought into contact with the photosensitive drums 61 by the primary transfer roller 42 so that a primary transfer portion is formed between the belt 41 and the photosensitive drums 61. Further, the printer 1 includes a secondary transfer roller 45 that contacts the belt 41 to form a secondary transfer portion. The secondary transfer portion is formed between the belt 41 and the secondary transfer roller 45. The rotational axis direction of the primary transfer roller 42, the rotational axis direction of the driving roller 46, the rotational axis direction of the tension roller 47, and the rotational axis direction of the secondary transfer roller 45 are parallel to each other. A pair of registration rollers 4 (hereinafter simply referred to as registration roller pair 4) is disposed in front of the secondary transfer portion (upstream in a conveyance direction of the sheet S).

The fixing unit 80 includes a heating member 82 including a heater (not shown) as a heat source, a pressure member 81 that nips and conveys the sheet S by pressing against the heating member 82 to form a fixing nip portion, and a flapper 5 that switches the conveyance direction of the sheet S to either a discharge path 1d or a reversing path 1e. When image forming operations are performed on the sheet S, the fixing unit 80 is disposed at a reference position, which is a first position shown in FIG. 1, and is configured to perform a fixing process in which an unfixed toner image is fixed to the sheet S by nipping and conveying the sheet S while heating it. Further, the sheet S on which the fixing has been performed is guided by a discharge roller pair 7 and is stacked on a discharge tray 1f outside the printer 1.

The operation panel 6 includes a function as a display means for displaying information relating to the status of the printer 1 and messages to a user, and a function as an input means for inputting various information from the user. The control unit 3 causes the operation panel 6 to display information according to the state of the printer 1. Further, the control unit 3 can also control the printer 1 in accordance with information inputted by the user.

Further, the printer 1 includes a length detection means for detecting a length of the sheet S in the conveyance direction when printing on the sheet S. The length detection means includes a sheet length sensor 110a, a conveyance sensor 110b, and the like. The sheet length sensor 110a is provided in the sheet feeding unit 30 and is a sensor capable of detecting the size of the sheet S stacked on the stacking tray 31. The conveyance sensor 110b is provided on a conveyance path of the sheet S, and the control unit 3 can obtain the length of the sheet S from the time for the sheet S to pass and the conveyance speed of the sheet S based on a detection result of the conveyance sensor 110b. The control unit 3 obtains the length of the sheet S in the conveyance direction based on the detection result of the sheet length sensor 110a and the conveyance sensor 110b. Further, the control unit 3 can also determine whether a jam has occurred by detecting the timing at which a leading end and a trailing end of the sheet S reach the conveyance sensor 110b. Further, the control unit 3 can also determine whether an abnormality has occurred within the printer 1 and whether the conveyance of the sheet S must be stopped. That is, the control unit 3 also functions as an abnormality detecting means. Furthermore, the control unit 3 can also predict, based on the detection result of the conveyance sensor 110b at the timing when an abnormality occurs and the conveyance of the sheet S stops, in which range on the conveyance path the leading end and the trailing end of the sheet S are located. Incidentally, the positions and numbers of the sheet length sensor 110a and the conveyance sensor 110b are not limited to the configuration shown in FIG. 1.

### Movement of transfer unit and tray unit

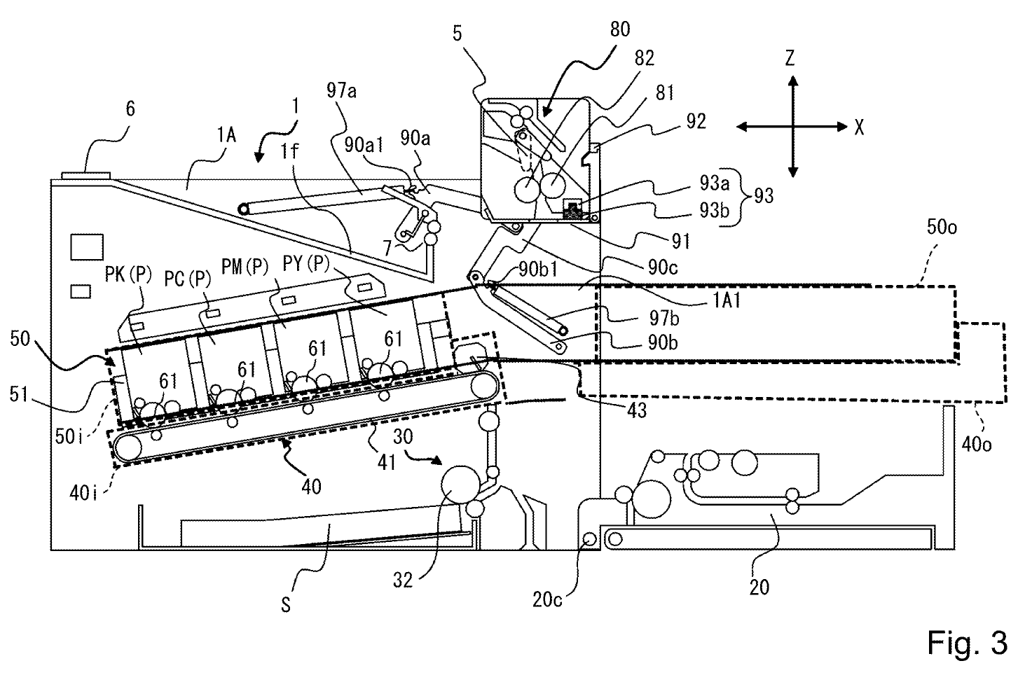

The movement of the transfer unit 40 and the tray unit 50 will be described with reference to FIGS. 1, 2, 3, and 4. FIG. 2 is a sectional view showing a state in which the door 20 is open, and FIG. 3 is a sectional view showing a state in which the fixing unit 80 has moved to a retracted position as a second position. The retracted position (second position) of the fixing unit 80 is higher in the Z direction than the reference position (first position). For this reason, hereinafter, the movement from the reference position to the retracted position will be referred to as lift-up.

As shown in FIG. 3, the transfer unit 40 and the tray unit 50 are movable from a position inside the casing 1A (hereinafter referred to as inner position) to a position outside the casing 1A (hereinafter referred to as outer position) through the opening 1A1 of the casing 1A by opening the door 20. The arrangement space before and after the transfer unit 40 and the tray unit 50 are moved, that is, an inner position 40i and an outer position 40o of the transfer unit 40, and an inner position 50i and an outer position 50o of the tray unit 50, are shown by dashed lines. In the X direction, the fixing unit 80 is disposed on the side of the opening 1A1 of the casing 1A.

The door 20 mounted on the casing 1A is rotatable around a rotational axis 20c and can rotate and move between the closed position and the open position. As shown in FIG. 1, when the door 20 is in the closed position, the door 20 covers the opening 1A1. On the other hand, as shown in FIG. 2, when the door 20 is in the open position, the inside of the casing 1A is exposed through the opening 1A1. Incidentally, FIG. 2 shows the door 20 in a fully open state.

As shown in FIG. 1, when the door 20 is in the closed position, the door 20 covers the fixing unit 80 mounted on the casing 1A. More specifically, when the door 20 is in the closed position, an upper cover portion 20b of the door 20 is positioned above the fixing unit 80. Further, when the door 20 is in the open position, that is, when the upper cover portion 20b is not positioned above the fixing unit 80, the fixing unit 80 can be lifted up to the retracted position on the opening 1A1 side, as shown in FIG. 2 to FIG. 3. Further, the fixing unit 80 is detachable from the printer 1, and is configured to be replaceable with a new fixing unit 80 when a consumable portion of the fixing unit 80 reaches the end of its life.

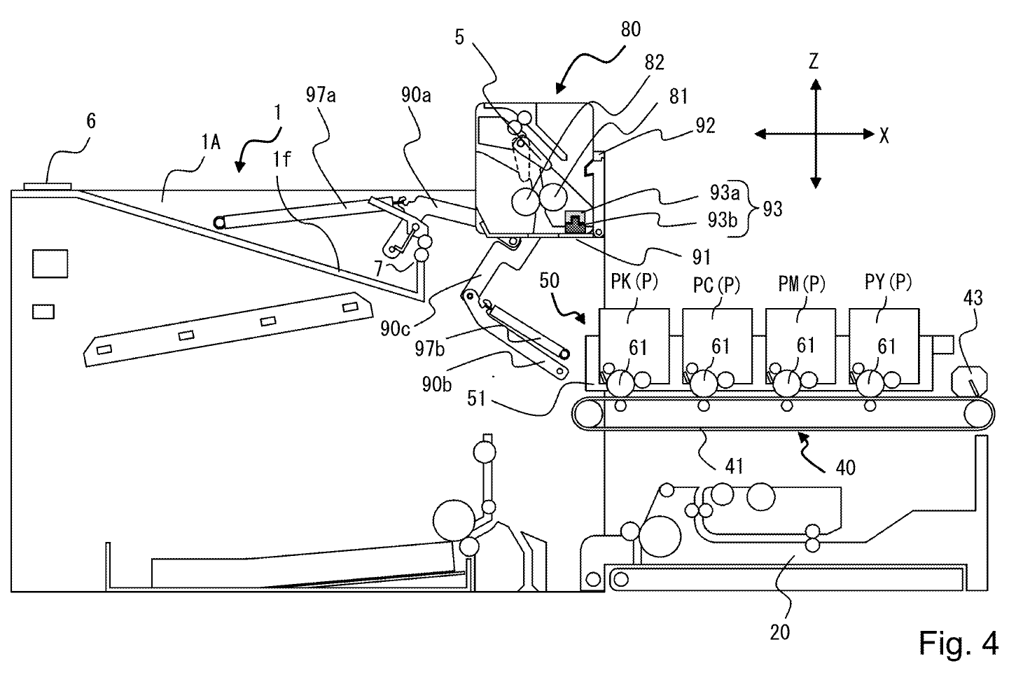

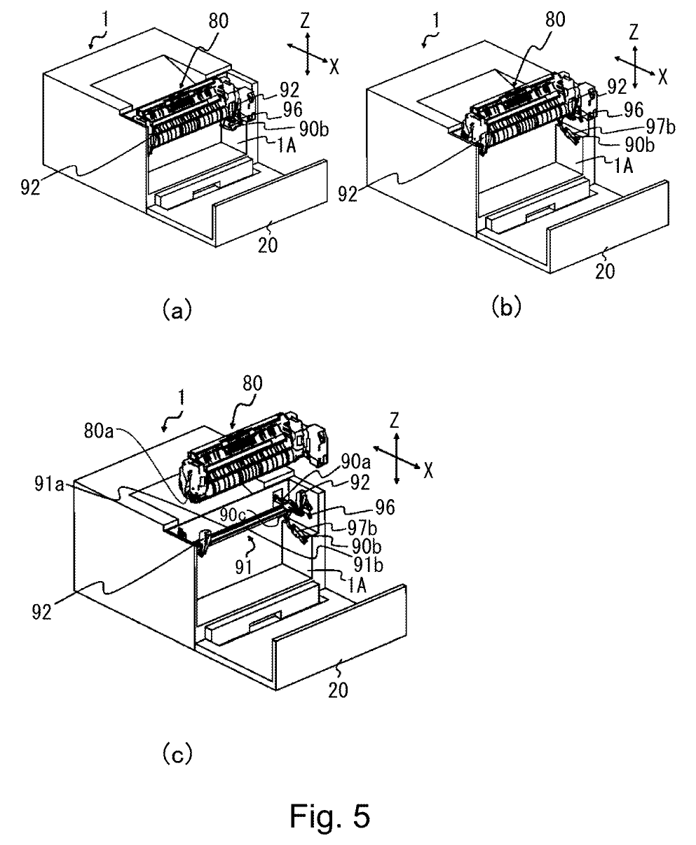

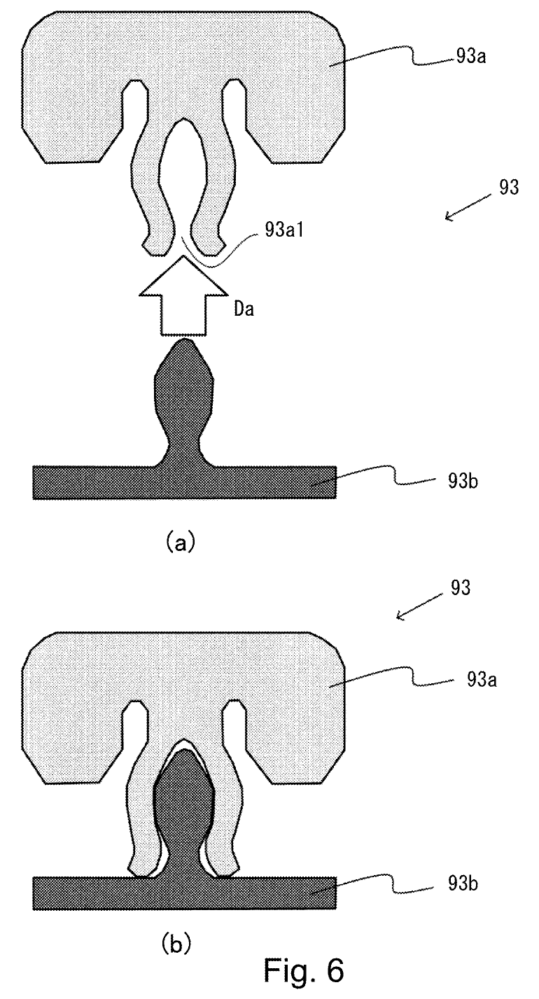

FIG. 4 shows a state in which the tray unit 50 and the transfer unit 40 have been moved to the outside of the casing 1A. In the state shown in FIG. 4, the cartridges PY, PM, PC, and PK can be removed from the tray 51, and the cartridges PY, PM, PC, and PK and can be attached to the tray 51. This allows the cartridges PY, PM, PC, and PK to be replaced with new cartridges PY, PM, PC, and PK.

Further, the transfer unit 40 can be pulled out and removed from a main assembly (casing 1A) independently of the tray unit 50, and can be replaced with a new transfer unit 40. The above is a description of the outline of the printer 1 in embodiment 1.

### Image forming operations

The image forming operations of the printer 1 will be described with reference to FIG. 1. The control unit 3 of the printer 1 starts the image forming operations on the sheet S based on an image signal received from an external host device 400. The external host device 400 is, for example, a personal computer, an image reader, a facsimile machine, or the like. When image formation is performed on the sheet S, the fixing unit 80 is disposed at the reference position, the tray unit 50 provided with the cartridges P of each color and the transfer unit 40 are disposed at the inner position, and the door 20 is disposed at the closed position.

A charging voltage is applied to the charging rollers 62, and the photosensitive drums 61 rotate. A laser beam corresponding to the image signal is irradiated from the scanner 2 onto the photosensitive drums 61, exposing a surface of the photosensitive drums 61 which have been charged by the charging rollers 62. This exposure forms an electrostatic latent image corresponding to the image signal on the surface of the photosensitive drums 61. A developing voltage is applied to the developing rollers 63 carrying the toner as the developer, and the electrostatic latent image formed on the photosensitive drums 61 is developed by the toner supplied from the developing rollers 63, forming a toner image as a visible image on the surface of the photosensitive drums 61. In embodiment 1, the developing rollers 63 develop the electrostatic latent image while in contact with the photosensitive drums 61, but the developing rollers 63 may also be configured to develop the electrostatic latent image with a gap between the developing rollers 63 and the photosensitive drums 61.

Incidentally, when the tray unit 50 is in the inner position, the developing rollers 63 are movable between a contact position where the developing rollers 63 contact the photosensitive drums 61 and a separated position where the developing rollers 63 are separated from the photosensitive drums 61. Specifically, a switching device (not shown) provided in the casing 1A switches between a state in which the developing rollers 63 are in the contact position and a state in which the developing rollers 63 are in the separated position. When the image forming operations are not being performed, the developing rollers 63 can be kept separated from the photosensitive drums 61. Further, the printer 1 can be in a state in which only the developing roller 63 and the photosensitive drum 61 corresponding to the cartridge PK are in contact to enable development, and the developing rollers 63 and the photosensitive drums 61 corresponding to the cartridges PY, PM, and PC can be in a separated state. This allows mono-color printing to be performed.

The toner images formed on the respective photosensitive drums 61 are transferred onto the belt 41 by the primary transfer roller 42 at the primary transfer portion, then moved toward the secondary transfer portion formed by the belt 41 and the secondary transfer roller 45. A full-color image is formed by superposing and transferring toner images formed on the respective photosensitive drums 61 of the cartridges PY, PM, PC, and PK onto the belt 41 (primary transfer).

On the other hand, a conveyance path 1c is formed in the casing 1A through which the sheet S heading toward the fixing unit 80 passes, and a double-side conveyance path 20a is formed inside the door 20 through which the sheet S that has passed through the fixing unit 80 passes thereafter. By opening the door 20, the conveyance path 1c and a part of the double-side conveyance path 20a are exposed.

In the sheet feeding unit 30, one sheet S is separated and fed from the sheets S stacked on the stacking tray 31 by the paper feed roller 32 at a predetermined timing, and the sheet S is conveyed toward the secondary transfer unit. In the secondary transfer portion, the toner image is transferred from the belt 41 to the sheet S (secondary transfer). Residual toner which was not transferred to the sheet S and which remains on the belt 41 is removed from the belt 41 by a cleaning blade 43A (cleaning member) provided in the cleaning portion 43.

The sheet S onto which the toner image has been transferred in the secondary transfer portion is conveyed toward the fixing unit 80. In the fixing unit 80, heat and pressure are applied to the sheet S in the fixing nip portion, and the unfixed toner image is fixed to the sheet S (fixing process). The sheet S onto which the toner image has been fixed is conveyed toward the flapper 5 as a conveyance path switching portion.

The flapper 5 is movable between a discharge position (solid line) where the sheet S that has passed through the fixing unit 80 is guided toward the discharge path 1d, and a reversal position (dashed line) where the sheet S is guided toward the reversing path 1e. When printing is performed on only one side, the sheet S is guided by the flapper 5 to the discharge path 1d, and is conveyed and discharged by the discharge roller pair 7 to the discharge tray 1f formed at the top portion of the casing 1A, thereby completing a series of image forming operations. On the other hand, when double-sided printing is performed, the sheet S is guided by the flapper 5 to the reversing path 1e. After the sheet S is guided to the reversing path 1e, the conveyance direction of the sheet S is reversed, and the sheet S passes through the double-side conveyance path 20a formed inside the door 20, and is conveyed again toward the secondary transfer portion. After that, after the toner image is transferred to the reverse side at the secondary transfer portion, the sheet S passes through the fixing unit 80 again, is guided by the flapper 5 to the discharge path 1d, and is stacked and discharged by the discharge roller pair 7 onto the discharge tray 1f, thereby completing the series of image forming operations.

The image forming operations of the printer 1 in embodiment 1 have been described above.

### Supporting structure of fixing unit

A supporting structure of the fixing unit 80 will be described with reference to FIGS. 2, 3 and 5. As shown in part (c) of FIG. 5, the fixing unit 80 is configured to be mounted on a mounting portion 91 which receives a bottom surface 80a of the fixing unit 80, and the mounting portion 91 is configured by connecting a metal frame 91a with a reinforcing shaft 91b.Part (c) of FIG. 5 shows a state in which the fixing unit 80 has moved above the mounting portion 91 and the mounting has been released.

As shown in FIG. 3, the mounting portion 91 is provided with arm members 90a, 90b, and 90c as movable connecting members that are movably connected to one another, and lift springs 97a and 97b as urging members attached between the arm members 90a, 90b, and 90c. Incidentally, the arm members 90a, 90b, and 90c may be collectively referred to as arm members 90, and the lift springs 97a and 97b may be collectively referred to as lift springs 97. Specifically, one end portion of the arm member 90a is movably connected to the casing 1A, and an other end portion of the arm member 90a is movably connected to one end portion of the arm member 90c. An other end portion of the arm member 90c is movably connected to one end portion of the arm member 90b. The arm member 90c is also rotatably connected to the metal frame 91a. An other end portion of the arm member 90b is movably connected to the casing 1A.

One end portion of the lift spring 97a is fixed to the casing 1A, and an other end portion of the lift spring 97a is engaged with an engaging portion 90a1 of the arm member 90a. One end portion of the lift spring 97b is fixed to the casing 1A, and an other end portion of the lift spring 97b is engaged with the engaging portion 90b1 of the arm member 90b. Incidentally, the arm members 90 and the lift springs 97 are provided at both end portions in a longitudinal direction of the fixing unit 80 (rotational axis direction of the pressure member 81). The mounting portion 91 is configured such that the fixing unit 80 can be lifted up from the reference position shown in FIG. 2 to the retracted position shown in FIG. 3 by an urging force of the lift springs 97a and 97b.

A pair of regulating members 92 shown in FIG. 5 are provided at both end portions of the fixing unit 80 in the longitudinal direction to regulate positional shift of the fixing unit 80 toward the door 20 in the X direction. The regulating members 92 are provided to have a function of preventing the fixing unit 80 mounted on the mounting portion 91 from falling into an open space formed when the door 20 is opened.

### Configuration and procedures for lift-up of fixing unit

Next, a configuration and procedures for lifting up the fixing unit 80 from the reference position to the retracted position will be described with reference to FIGS. 2, 3, and 5. First, as shown in FIG. 2, the door 20 of the printer 1 is moved to the open position to form the open space for lifting up the fixing unit 80. Here, the fixing unit 80 is locked by a fixing locking means (not shown) provided to lock the fixing unit 80 in the reference position so that the fixing unit 80 is not lifted up simply by opening the door 20. In embodiment 1, the fixing locking means for locking the fixing unit 80 and the mounting portion 91 in the reference position during image formation is configured to lock the fixing unit 80 to a locked portion (not shown) of the casing 1A, but is not limited to this. For example, the fixing locking means may be configured to lock the mounting portion 91 or the arm members 90a, 90b, and 90c shown in FIG. 3 and the like to the casing 1A.

As shown in FIG. 5, the mounting portion 91 includes a releasing lever 96 that releases a locked state of the fixing unit 80. The releasing lever 96 can be switched between the locked state in which the fixing unit 80 is locked to the casing 1A, and a released state in which the fixing unit 80 is released from the casing 1A. For example, the releasing lever 96 can be switched between the locked state and the released state due to user operation. When the releasing lever 96 releases the locked state of the fixing unit 80 and the mounting portion 91, the arm members 90 operate to lift up the fixing unit 80 and the mounting portion 91 by the urging force of the lift springs 97a and 97b shown in FIG. 2, without the user having to apply any force. By this, the fixing unit 80 and the mounting portion 91 are automatically lifted up from the reference position toward the retracted position.

Here, as shown in FIG. 2, the printer 1 includes a restraint portion 93 as a restraint member (restraining means). The restraint portion 93 includes a first restraint member 93a provided on the casing 1A and a second restraint member 93b provided on the mounting portion 91. The first restraint member 93a and the second restraint member 93b are disposed to combine at a location corresponding to a vicinity of the outside of both end portions in the longitudinal direction of the fixing unit 80 when the fixing unit 80 is in the retracted position (FIG. 3). The first restraint member 93a and the second restraint member 93b are not combined and are apart from each other (FIG. 2) when the fixing unit 80 is in the reference position during image formation (part (a) of FIG. 5, etc.). The second restraint member 93b moves (rises) interrelatedly with the lift-up operation of the fixing unit 80 and the mounting portion 91, and when the the fixing unit 80 and the mounting portion 91 reach the retracted position as shown in FIG. 3 (part (b) of FIG. 5, etc.), the second restraint member 93b combines with the first restraint member 93a. This allows the restraint portion 93 to be configured to generate a force for restraining the fixing unit 80 and the mounting portion 91 to the retracted position.

### Detailed configuration and action of restraint portion

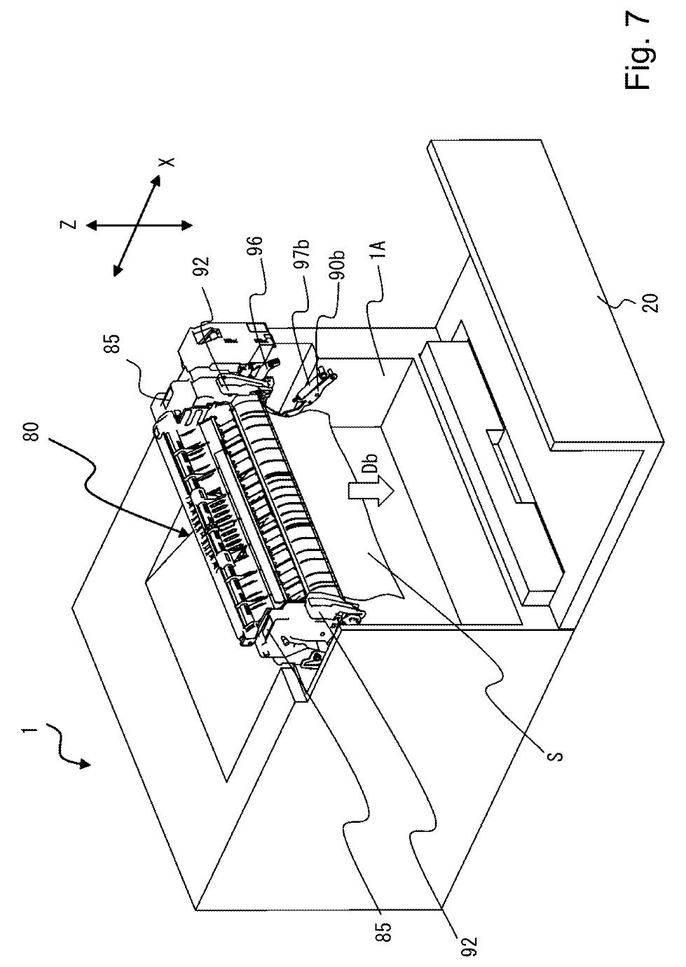

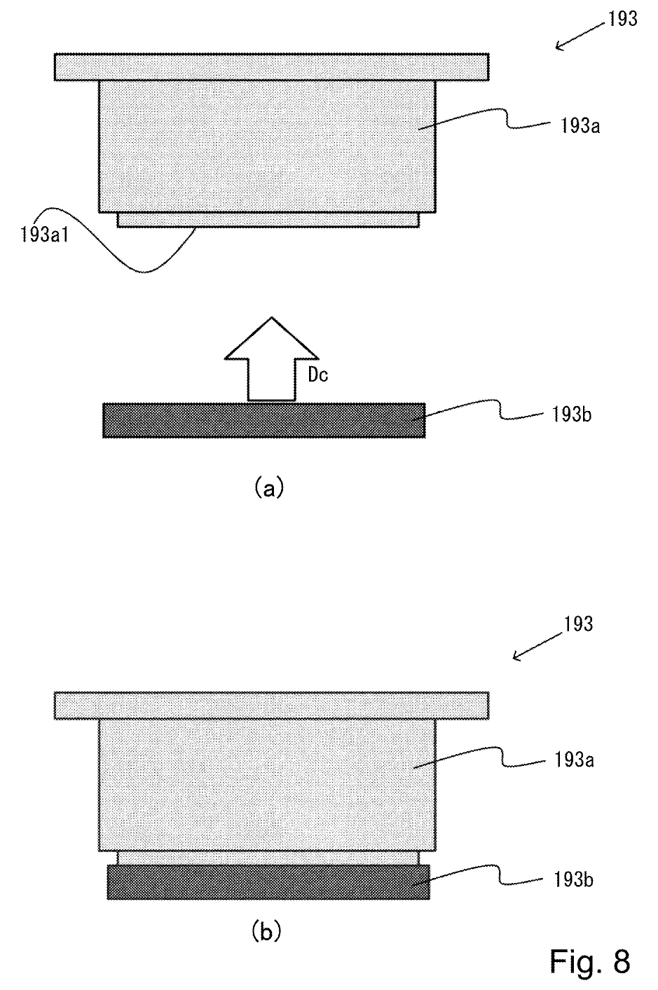

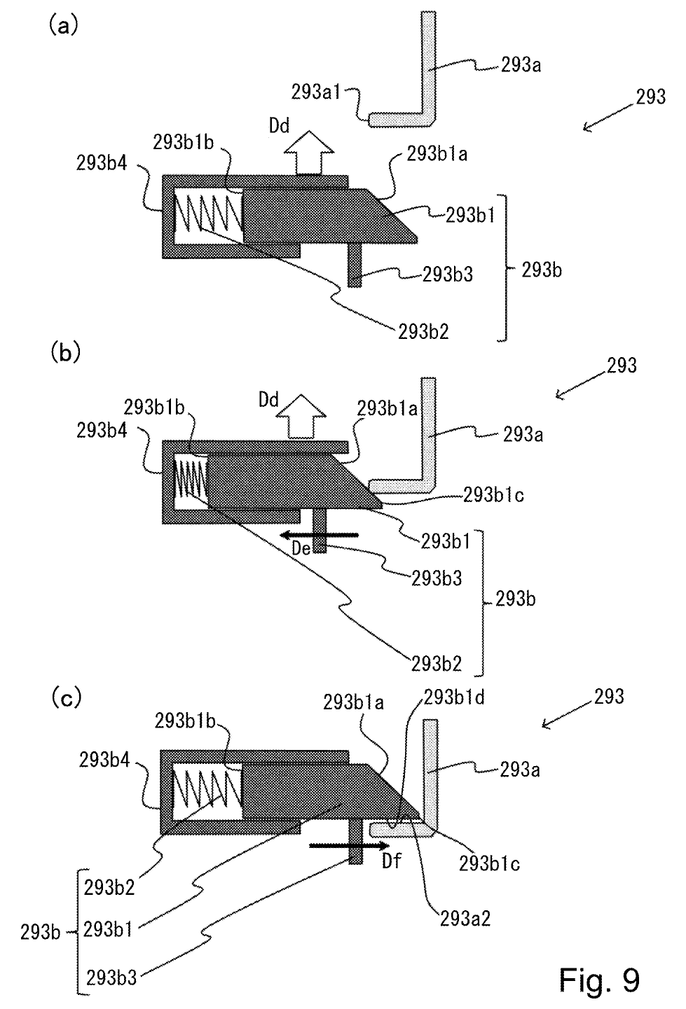

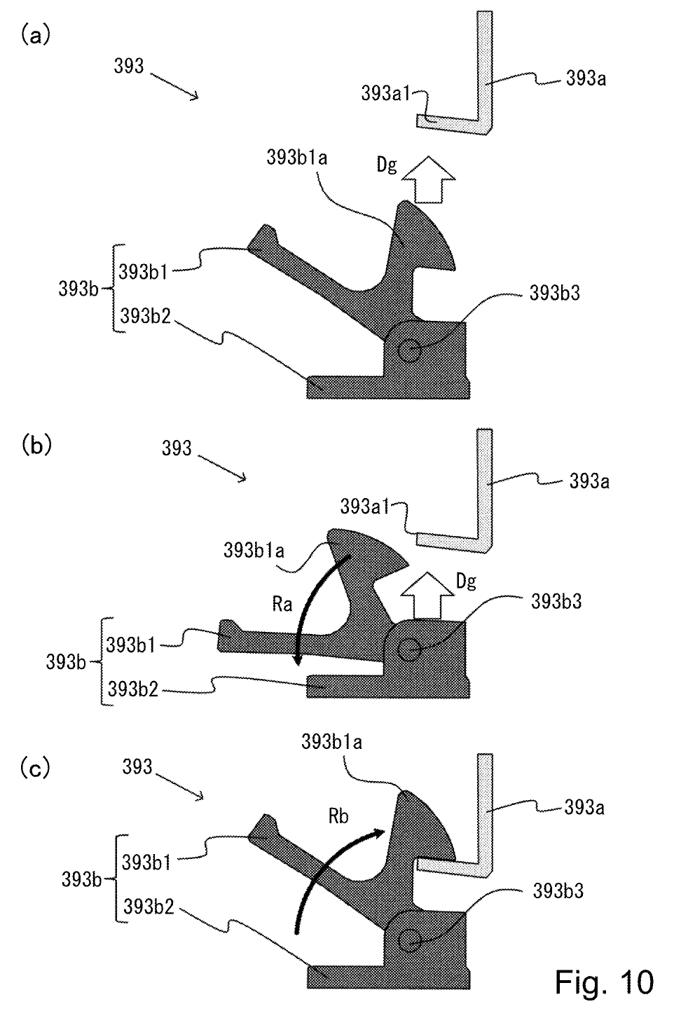

A detailed configuration and action of the restraint portion 93 in embodiment 1 will be described with reference to FIGS. 6 and 7. FIG. 6 shows an example in which a catch mechanism made of resin is mounted as the restraint portion 93. One of the first restraint member 93a and the second restraint member 93b is a male shape and the other is a female shape. A restraint force is generated by the male shape and the female shape being fitted with each other, and the restraint force is released by a reaction force greater than the restraint force.

For example, the first restraint member 93a is a member formed of a resin such as polyacetal (POM), and is a female shape that can grip the second restraint member 93b by its elastic deformation. The second restraint member 93b is a member formed of the same material as the first restraint member 93a, and is a male shape that can be inserted into the first restraint member 93a. Incidentally, the restraint portion 93 may be configured with an elastically deformable non-metallic material other than resin. Further, a similar mechanism may be configured using a metallic material such as stainless steel (SUS) or the elasticity of a spring member.

The second restraint member 93b is provided on the mounting portion 91, and moves interrelatedly with the lift-up operation of the fixing unit 80 in an arrow direction Da toward an insertion port 93a1 of the first restraint member 93a when the fixing unit 80 reaches the retracted position (part (a) of FIG. 6). Further, the second restraint member 93b is lightly pressed into and combined with the first restraint member 93a, and the fixing unit 80 is locked in the retracted position (part (b) of FIG. 6).

Here, a force necessary for moving the fixing unit 80, which is locked in the retracted position, from the retracted position by applying a force for returning the fixing unit 80 in the direction of the reference position, is set to be larger than a force necessary for moving the sheet S, which is in a state of being nipped in the fixing nip portion, and pulling the sheet S to a direction approaching the reference position (the upstream side in the conveyance direction of the recording material). That is, the restraint force of the restraint portion 93 is set so that the fixing unit 80 does not move while remaining restrained in the retracted position, while the sheet S, which is restrained in the fixing nip portion of the fixing unit 80 which is locked in the retracted position, is pulled and moved to the upstream side in the conveyance direction.

Here, a force for lifting up the fixing unit 80 to the retracted position side by the urging force of the lift springs 97a and 97b is set to, for example, +13N. Further, the force for restraining the fixing unit 80 in the retracted position (the force of the restraint portion 93 itself) by the restraint portion 93 is set to, for example, +7N. Furthermore, the force for returning the fixing unit 80 to the reference position side by its own weight is set to, for example, -10N. Incidentally, a force acting on the retracted position side of the fixing unit 80 is defined as positive, and a force acting on the reference position side is defined as negative. In embodiment 1, the force for restraining the fixing unit 80 in the retracted position is set to +10N (=+13N+7N-10N), which is the resultant force of these three forces. Further, a force for restraining the sheet S to the fixing nip portion of the fixing unit 80 in a state in which a conveyance of the sheet S is stopped due to a malfunction of the printer 1 or the like is set to 8N. Incidentally, in the following description, a state in which the conveyance of the sheet S is stopped due to a malfunction of the printer 1 or the like will be referred to hereinafter as a jam.

With this setting, in the event of a jam, when the door 20 is opened as shown in FIG. 7, the fixing unit 80 is lifted up to the retracted position, and the sheet S restrained in the fixing nip portion is removed by pulling the sheet S in an arrow direction Db, the configuration of embodiment 1 makes it easier to remove the sheet S. Here, the arrow direction Db is a direction toward the upstream side in the conveyance direction of the sheet S, and is also a direction from the retracted position toward the reference position in the fixing unit 80. Further, the process of removing the sheet S restrained in the fixing nip portion by pulling the sheet S in the arrow direction Db (process of removal) will be referred to hereinafter as jam processing.

When the force applied to pull the sheet S in the arrow direction Db during jam processing exceeds the restraint force (8N) in the fixing nip portion, the sheet S begins to move to the upstream side in the conveyance direction, allowing the sheet S to be removed from the fixing nip portion. While the sheet S is being pulled with a force equal to or larger than the restraint force (for example, a force of 8N or more as described above) of the sheet S by the fixing unit 80, that force does not exceed the force (10N) for restraining the fixing unit 80 in the retracted position, so the fixing unit 80 remains locked in the retracted position and does not move. This improves the jam processing performance.

On the other hand, in the conventional example without the restraint portion 93, the force for restraining the fixing unit 80 in the retracted position is the resultant force of the force [+13N] for lifting up the fixing unit 80 to the retracted position side by the urging force of the lift springs 97a and 97b, and the force [-10N] for returning the fixing unit 80 to the reference position side by its own weight. That is, the resultant force is +3N (=+13N-10N). The force for restraining the sheet S to the fixing nip portion when a jam occurs is 8N. For this reason, when jam processing is attempted by pulling the sheet S to the reference position side of the fixing unit 80, the force for pulling the sheet S becomes larger than the resultant force before the sheet S moves from the fixing nip portion, and the fixing unit 80 moves from the retracted position to the reference position side. For the above reasons, it is difficult to remove the sheet S with the conventional configuration.

In embodiment 1, after processing the jammed sheet S, the user pushes a handle 85 of the fixing unit 80 to the reference position side with a force equal to or larger than the force for restraining the fixing unit 80 in the retracted position (a force of 10N or more in embodiment 1). This releases the restraint force of the restraint portion 93 (the state changes from that of part (b) of FIG. 6 to that of part (a) of FIG. 6).

After the restraint by the restraint portion 93 is released, the own weight (-10N) of the fixing unit 80 is supported only by the urging force (+13N) of the lift springs 97a and 97b, and that resultant force (+3N) maintains the fixing unit 80 in the retracted position. After the restraint of the restraint portion 93 is released, the user pushes the handle 85 of the fixing unit 80 into the reference position side with a force (a force of 3N or more in embodiment 1) obtained by subtracting the restraint force of the restraint portion 93. This moves the fixing unit 80 and returns it to the reference position, and the door 20 is closed to perform a return operation from jam processing and the printer 1 can return to an image formable state.

### Modification 1 of restraint portion

FIG. 8 is a diagram showing a modification of the restraint members. A restraint portion 193 as a restraint member (restraining means) in the modification is an example equipped with a magnet catch mechanism. One of a first restraint member 193a and a second restraint member 193b includes a material having a magnetic force or a structure for generating the magnetic force and the other is a material in which an attractive force is generated by the magnetic force. The restraint force is generated by directly or indirectly attracting of the first restraint member 193a and the second restraint member 193b, and the restraint force is released by a reaction force greater than the restraint force. For example, the first restraint member 193a is a magnet member composed of a permanent magnet and a holding member, and the second restraint member 193b is a receiving member composed of magnetic material including iron components or the like. Incidentally, the magnet member may be any structure that generates magnetic force, such as an electromagnet.

Similar to the resin catch mechanism in FIG. 6, the first restraint member 193a is provided on the casing 1A side, and the second restraint member 193b is provided on the mounting portion 91 and moves interrelatedly with the lift-up operation of the fixing unit 80. When the fixing unit 80 reaches the retracted position, the second restraint member 193b moves in an arrow direction Dc toward an attraction surface 193a1 of the first restraint member 193a (part (a) of FIG. 8), and is combined (attracted) by the magnetic force of the first restraint member 193a. This locks the fixing unit 80 in the retracted position (part (b) of FIG. 8).

Here, the force necessary for moving the fixing unit 80 from the retracted position is set to be larger than the force necessary for pulling the sheet S, which is in a state of being nipped in the fixing nip portion of the fixing unit 80, to a direction approaching the reference position, similar to the resin catch mechanism in FIG. 6. This provides the same effect as the restraint portion 93 in FIG. 6.

### Modification 2 of restraint portion

FIG. 9 is a diagram showing an example of a latch mechanism in which a restraint portion 293 as a restraint member (restraining means) of modification 2 is used. A first restraint member 293a and a second restraint member 293b include a locking portion lockable while being fitted with each other and a releasing portion releasable by the locking portion while being separated from each other. The restraint force is generated by the locking portion, and a lock of the locking portion is released by the releasing portion.

FIG. 9 shows a latch mechanism used in, for example, a doorknob, and the restraint portion 293 includes the first restraint member 293a and the second restraint member 293b. The first restraint member 293a is provided on the casing 1A side, and the second restraint member 293b is provided on the mounting portion 91. The second restraint member 293b includes a latch bolt 293b1, a latch spring 293b2, a releasing lever 293b3, and a frame 293b4. One end surface of the latch bolt 293b1 is a slope 293b1a, and an other end surface 293b1b of the latch bolt 293b1 is connected to one end portion of the latch spring 293b2. The slope 293b1a can come into contact with one end portion 293a1 of the first restraint member 293a. An other end portion of the latch spring 293b2 is fixed to the frame 293b4.

When the second restraint member 293b is lifted up in an arrow direction Dd (part (a) of FIG. 9), the latch bolt 293b1 contacts the end portion 293a1 of the first restraint member 293a, and the end portion 293a1 moves on the slope 293b1a. This allows the latch bolt 293b1 to slide in an arrow direction De within the frame 293b4 (part (b) of FIG. 9). The movement of the latch bolt 293b1 in the arrow direction De causes the latch spring 293b2 to contract. When the end portion 293a1 of the first restraint member 293a passes over a corner portion 293b1c of the latch bolt 293b1, the urging force of the latch spring 293b2 moves the latch bolt 293b1 in an arrow direction Df in part (c) of FIG. 9. As a result, a lower surface 293b1d of the latch bolt 293b1 and a surface 293a2 of the first restraint member 293a oppose each other. In other words, the latch bolt 293b1 is locked to the first restraint member 293a by the urging force of the latch spring 293b2. The latch bolt 293b1 and the first restraint member 293a correspond to the locking portion. The latch mechanism can have a stronger restraint force than the catch mechanism described above.

In modification 2, in order to release the restraint force of the restraint portion 293, a release operation by the releasing lever 293b3 is required. That is, in the state shown in part (c) of FIG. 9, when the user presses the releasing lever 293b3 in the arrow direction De in part (b) of FIG. 9, the engagement between the first restraint member 293a and the latch bolt 293b1 is released. The releasing lever 293b3 corresponds to the releasing portion.

### Modification 3 of restraint portion

FIG. 10 shows an example of another latch mechanism as a restraint portion 393 as a restraint member (restraining means) in modification 3. FIG. 10 shows a lever-rotation type latch mechanism, and the restraint portion 393 includes a first restraint member 393a and a second restraint member 393b. The first restraint member 393a is provided on the casing 1A side, and the second restraint member 393b is provided on the mounting portion 91.

The first restraint member 393a includes an engaging portion 393a1 (locking portion). The second restraint member 393b includes a lever portion 393b1 and a supporting portion 393b2. The lever portion 393b1 includes an engaging portion 393b1a (locking portion). The supporting portion 393b2 has a rotational axis 393b3 rotatably attached thereto, and the lever portion 393b1 is rotatably attached around the rotational axis 393b3.

While the fixing unit 80 is being lifted up from the reference position toward the retracted position, the second restraint member 393b moves in an arrow direction Dg in part (a) of FIG. 10. At this time, the user rotates the lever portion 393b1 in a rotational direction Ra in part (b) of FIG. 10, thereby retracting the engaging portion 393b1a so as not to interfere with the engaging portion 393a1 of the first restraint member 393a. When the fixing unit 80 is further lifted up in this state, the engaging portion 393b1a of the second restraint member 393b moves upward in the vertical direction beyond the engaging portion 393a1 of the first restraint member 393a. At this time, if the user rotates the lever portion 393b1 in a rotational direction Rb in part (c) of FIG. 10, the engaging portion 393b1aand the engaging portion 393a1 are locked together by a biasing member (not shown). Incidentally, in the state of part (c) of FIG. 10, by rotating the lever portion 393b1 (releasing portion) in the rotational direction Ra in part (b) of FIG. 10, the engagement is released.

Other modifications include a ball-catch type catch mechanism in which a restraint force is generated by a receiving seat being clamped between ball members clamped by a spring force. Further, the latch mechanism may be a bolt lock type or a padlock type that uses a rod-shaped or plate-shaped member to lock and release each other. In either case, when the fixing unit 80 is restrained in the retracted position and the sheet S is pulled to the upstream side in the conveyance direction to perform jam processing, the same effect can be obtained as long as the restraining means can apply a restraint force that prevents the fixing unit 80 from moving from the retracted position.

As described above, in embodiment 1, the image forming apparatus includes a restraining means that restrains the fixing unit in the retracted position. In such an image forming apparatus, the force for restraining the fixing unit in the retracted position is made larger than the force holding the sheet restrained in the fixing nip portion of the fixing unit in the retracted position and moving the sheet in a direction approaching the reference position. As a result, after the fixing unit is lifted up to the retracted position, the fixing unit remains locked in the retracted position and does not move while the sheet nipped in the fixing nip portion is being pulled to the upstream side in the conveyance direction, thereby improving the jam processing performance.

Incidentally, in embodiment 1, an example was described in which the restraint portions 93, 193, 293, and 393 are disposed at locations corresponding to the vicinity of the outside of both end portions in the longitudinal direction of the fixing unit 80, but the present invention is not limited to this. For example, the restraint portion may be disposed at a position that does not interfere with the lift-up of the fixing unit 80, the conveyance of the sheet S, the opening and closing of the door 20, or other image forming operations. Further, although an example was described in which the second restraint members 93b, 193b, 293b, and 393b are disposed in the mounting portion 91, the second restraint members 93b, 193b, 293b, and 393b may be disposed in the fixing unit 80 or in the arm members 90. That is, the second restraint members 93b, 193b, 293b, and 393b may move interrelatedly to the lift-up operation of the fixing unit 80. Furthermore, since the first restraint members 93a, 193a, 293a, and 393a, and the second restraint members 93b, 193b, 293b, and 393b can be combined in the retracted position by lifting up the fixing unit 80, the first restraint members 93a, 193a, 293a, and 393a, and the second restraint members 93b, 193b, 293b, and 393b may be configured to be interchangeable with each other in consideration of the arrangement space or the like.

As described above, according to embodiment 1, it is possible to improve the jam processing performance when the recording material nipped in the fixing unit in the retracted position is pulled to the upstream side in the conveyance direction to perform jam processing.

### Embodiment 2

In embodiment 2, flows for performing jam processing to a sheet S nipped in the fixing unit 80 when a jam occurs during printing by the printer 1 equipped with the restraining means in embodiment 1 will be described. Specifically, an example will be described in which the user is notified of a process that is effective for jam processing depending on the situation. The configuration of the printer and the fixing unit in embodiment 2 are the same as those in embodiment 1, so a description of the common parts will be omitted.

The printer 1 in embodiment 2 includes a notifying means to notify the user of a jam processing flow for returning the printer 1 to a printable state when a jam occurs during printing and the conveyance of the sheet S is stopped. Examples of notifying means include a display member (not shown) having a screen capable of displaying contents and images of the jam processing flow, and a guide member (not shown) having a function of guiding the user through the jam processing flow using voice and light. These members may also serve as an operating portion for directly operating function settings and the like of the printer 1. For this reason, in embodiment 2, the operation panel 6 described with reference to FIG. 1 will be described as the notifying means.

Further, as described in embodiment 1, the printer 1 includes the sheet length sensor 110a provided in the sheet feeding unit 30 for detecting the size of the sheet S, the conveyance sensor 110b provided on the conveyance path, and the like (see FIG. 1). The control unit 3 obtains a length of the sheet S in the conveyance direction based on the detection results of the sheet length sensor 110a, the conveyance sensor 110b, and the like. Further, by detecting the timing at which the leading end and the trailing end of the sheet S arrive using the conveyance sensor 110b, the control unit 3 can predict the range where the leading end and the trailing end of the sheet S exists on the conveyance path at the timing when a jam occurs and the conveyance of the sheet S is stopped. The control unit 3 also functions as a predicting means.

### Jam processing flows

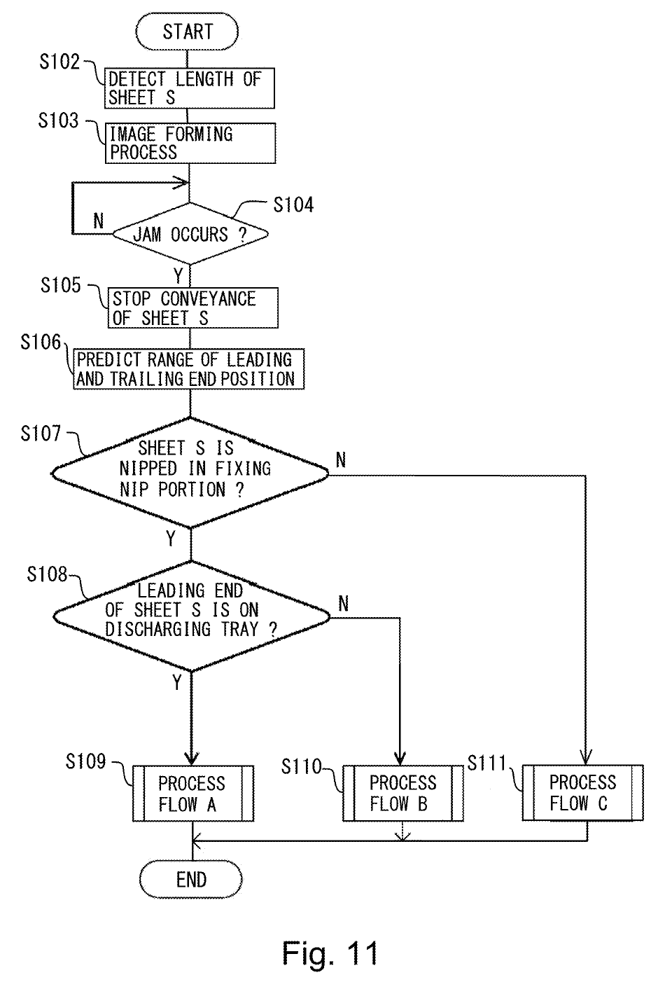

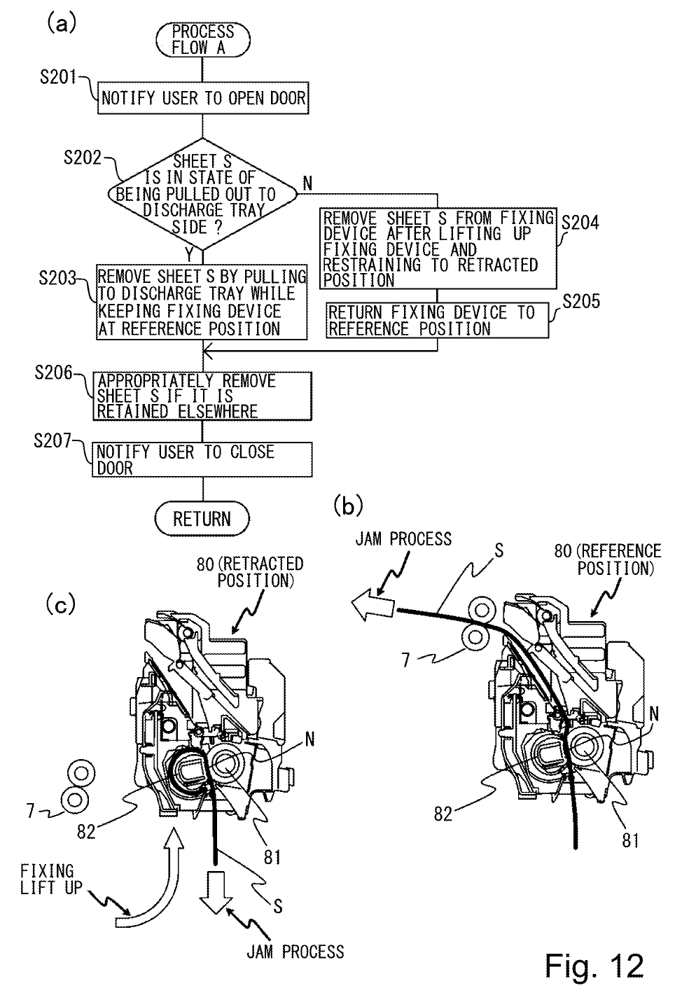

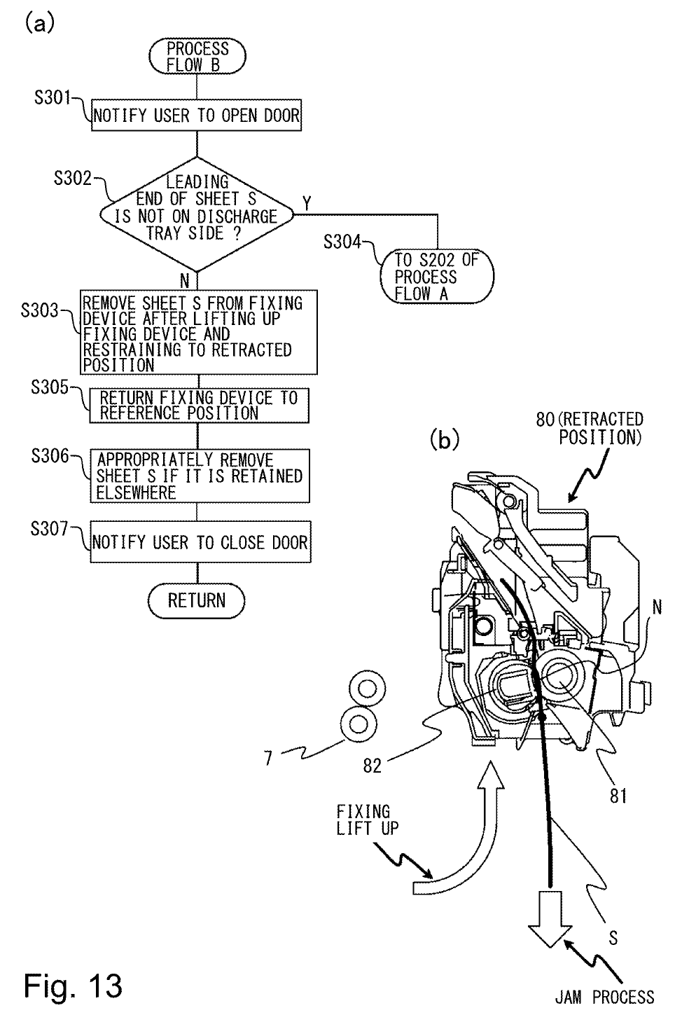

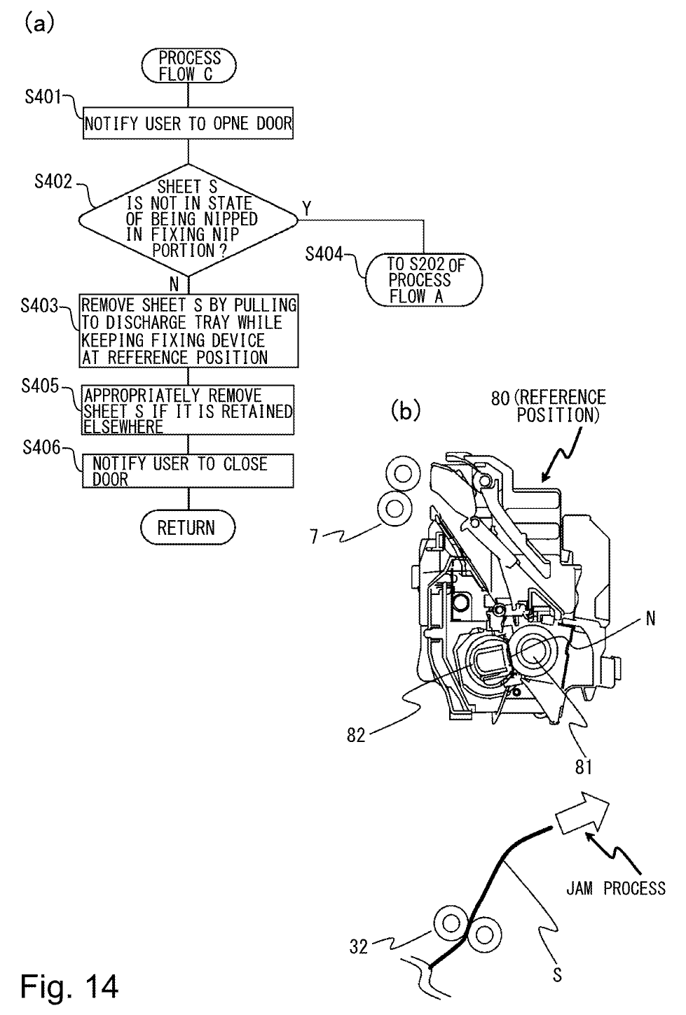

Jam processing flows for the sheet S in embodiment 2 will be described with reference to FIG. 11. In Step (hereinafter referred to as S) 102, the control unit 3 detects the length of the sheet S in the conveyance direction by a sensor or the like when printing on the sheet S. In S103, the control unit 3 executes the image forming process. In S104, the control unit 3 determines whether a jam has occurred during printing. In S104, if the control unit 3 determines that a jam has not occurred, the process returns to S104, and if the control unit 3 determines that a jam has occurred, the process proceeds to S105. Incidentally, the control unit 3 can determine that a jam has occurred when, for example, the leading end of the sheet S cannot be detected at a predetermined timing by the conveyance sensor 110b or the like provided on the conveyance path.

In S105, the control unit 3 stops the conveyance of the sheet S. In S106, the control unit 3 predicts the range of a leading end position and a trailing end position (hereinafter referred to as leading and trailing end positions) of the sheet S (retained recording material) retained in the conveyance path of the printer 1, based on the timing at which the jam occurred and the length of the sheet S in the conveyance direction obtained in S102. In S107, the control unit 3 determines whether there is a possibility that the sheet S is nipped in the fixing nip portion, based on the range of the leading and trailing end positions of the sheet S predicted in S106.

In S107, if the control unit 3 determines that the possibility of the sheet S being nipped in the fixing nip portion is low, the process proceeds to S111. The process then proceeds to a process flow C, and the process in FIG. 11 ends. The process flow C will be described later. In S107, if the control unit 3 determines that the possibility of the sheet S being nipped in the fixing nip portion is high, the process proceeds to S108. In S108, the control unit 3 determines whether the leading end of the sheet S is near the discharge tray 1f based on the prediction in S106.

In S108, if the control unit 3 determines that the possibility of the leading end of the sheet S being on the discharge tray 1f is high, the process proceeds to S109. The process then proceeds to a process flow A, and the process in FIG. 11 ends. The process flow A will be described later. In S108, if the control unit 3 determines that the possibility of the leading end of the sheet S being on the discharge tray 1f is low, the process proceeds to S110. The process then proceeds to a process flow B, and the process in FIG. 11 ends. The process flow B will be described later. Thus, the control unit 3 changes (selects) the jam processing process depending on whether the sheet S retained in the printer 1 is nipped in the fixing nip portion, and if the sheet S retained in the printer 1 is nipped in the fixing nip portion, whether the leading end of the sheet S has reached the discharge tray 1f.

### Process flow A

The process flow A in S109 in FIG. 11 will be described with reference to FIG. 12. The process flow A is a jam processing flow for when a jam has occurred,

the sheet S is nipped in a fixing nip portion N, and the possibility of the leading end of the sheet S being on the discharge tray 1f is high. In such a state, the control unit 3 notifies the user of the jam processing flow via the operation panel 6.

Part (a) of FIG. 12 shows a flow chart for the process flow A. In S201, the control unit 3 notifies the user via the operation panel 6 to open the door 20. In S202, the control unit 3 prompts the user via the operation panel 6 to check whether the leading end of the sheet S is on the discharge tray 1f, that is, whether the sheet S can be pulled toward the discharge tray 1f. As a result of confirmation in S202, if the sheet S can be pulled toward the discharge tray 1f, the process proceeds to S203. At this time, the sheet S is in the state shown in part (b) of FIG. 12. In S203, the user removes the sheet S by pulling it toward the discharge tray 1f while maintaining the fixing unit 80 in the reference position (second process flow). As a result of confirmation in S202, if the sheet S cannot be pulled toward the discharge tray 1f, the process proceeds to S204. A state in which the sheet S cannot be pulled toward the discharge tray 1f is, for example, when the leading end of the sheet S is wound around the heating member 82 as shown in part (c) of FIG. 12.

In S204, the user lifts up the fixing unit 80 as shown in part (c) of FIG. 12, and removes the sheet S from the fixing unit 80 by restraining the fixing unit 80 with the restraint portion 93 or the like in the retracted position (first process flow). By restraining the fixing unit 80 in the retracted position, it becomes possible to remove the sheet S while avoiding the risk of the user’s fingers coming into contact with the belt 41 of the transfer unit 40 or the like and causing injury during jam processing, thereby improving the jam processing performance. Further, due to the action of the restraint portion 93 and the like described in embodiment 1, the fixing unit 80 does not return to the reference position during jam processing.

After removing the sheet S from the fixing unit 80, the user lifts up the fixing unit 80 in S205, so the user returns the fixing unit 80 to the reference position, and the

process proceeds to S206. In S206, the user also checks whether the sheet S is retained elsewhere in the printer 1, and if the sheet S is retained elsewhere in the printer 1, the user removes the sheet S as appropriate. Here, the control unit 3 may display a message such as "Can you pull the sheet toward the discharge tray?" on the operation panel 6 during confirmation in S202. The control unit 3 may also obtain a confirmation result from the user by, for example, displaying virtual buttons such as "Yes" and "No" on the operation panel 6 that the user can operate in response to this message. Further, the control unit 3 may display on the operation panel 6 a message prompting the user to perform the operations in S203 to S206 in response to the user’s input. In S207, the control unit 3 notifies the user via the operation panel 6 to close the door 20. When the user closes the door 20, the control unit 3 executes a return operation sequence from jam processing. This returns the printer 1 to a printable state.

### Process flow B

Next, the process flow B of S110 in FIG. 11 will be described with reference to FIG. 13. The process flow B is a jam processing flow for when a jam has occurred, the sheet S is nipped in the fixing nip portion N, and the possibility of the leading end of the sheet S not being on the discharge tray 1f is high. The control unit 3 notifies the user of the jam processing flow via the operation panel 6.

Part (a) of FIG. 13 shows a flow chart for the process flow B. Incidentally, S301, S303, and S305 to S307 are similar to the processes in S201, and S204 to S207 in part (a) of FIG. 12, and the description thereof will thereby be omitted. In S302, the control unit 3 prompts the user via the operation panel 6 to check whether the leading end of the sheet S is not on the discharge tray 1f side. As a result of confirmation in S302, if the leading end of the sheet S is not on the discharge tray 1f, the process proceeds to S303. In this case, as shown in part (b) of FIG. 13, the fixing unit 80 is lifted up and restrained in the retracted position, and the sheet S is removed from the fixing unit 80. As a result of confirmation in S302, if the leading end of the sheet S is on the discharge tray 1f side, the process proceeds to S304. In S304, the process proceeds to S202 of the process flow A.

### Process flow C

Next, the process flow C of S111 in FIG. 11 will be described with reference to FIG. 14. The process flow C is a jam processing flow for when a jam has occurred and the possibility of the sheet S not being nipped in the fixing nip portion N is high. The control unit 3 notifies the user of the jam processing flow via the operation panel 6.

Part (a) of FIG. 14 shows a flow chart for the process flow C. Incidentally, S401, S403, S405, and S406 are similar to the processes of S201, S203, S206, and S207 in part (a) of FIG. 12, and the description thereof will thereby be omitted. In S402, the control unit 3 prompts the user via the operation panel 6 to check whether the sheet S is not nipped in the fixing nip portion N.

As a result of confirmation in S402, for example, if the leading end of the sheet S is between the paper feed and fixing, the sheet S is not nipped in the fixing nip portion N as shown in part (b) of FIG. 14. In this case, as shown in part (b) of FIG. 14, the fixing unit 80 remains in the reference position, and the sheet S is removed by pulling it in a direction that makes it easier to remove the sheet S. As a result of confirmation in S402, if the sheet S is nipped in the fixing nip portion N, the process proceeds to S404. In S404, the process proceeds to S202 of the process flow A.

As described above, according to embodiment 2, when a jam has occurred during printing, it is possible to notify the user of a process flow that is effective for jam processing, including whether or not to lift up the fixing unit, depending on the range on the conveyance path where the sheet S is retained.

As described above, according to embodiment 2, it is possible to improve the jam processing performance when the recording material nipped in the fixing unit in the retracted position is pulled to the upstream side in the conveyance direction to perform jam processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2025-018719, filed on February 6, 2025, which is hereby incorporated by reference herein in its entirety.

What is claimed is:

1. An image forming apparatus for forming an image on a recording material, the image forming apparatus comprising:
a main assembly;
a fixing unit accommodated in the main assembly and configured to perform a fixing process to a toner image formed on the recording material while nipping and conveying the recording material at a nip portion;
a connecting member configured to connect the main assembly and the fixing unit;
an urging member configured to urge the connecting member and operate the connecting member; and
an open/close member openably/closably provided to the main assembly so as to be in an open state in which the fixing unit is exposed as seen from an outside of the main assembly and in a closed state in which the fixing unit is hidden as seen from the outside of the main assembly,
wherein the fixing unit is movable between a first position which is a position of the fixing unit when the open/close member is in the closed state and where the fixing process is performed, and a second position which is a position of the fixing unit when the open/close member is in the open state and where the fixing unit is moved from the first position by an operation of the connecting member caused by the urging member, and includes a restraint member configured to restrain the fixing unit to the second position, and
wherein a force necessary for moving the fixing unit, which is in the second position restrained by the restraint member, toward the first position is larger than a force necessary for pulling the recording material, which is in a state of being nipped in the nip portion of the fixing unit, out of the nip portion to an upstream side in a conveyance direction of the recording material.

2. The image forming apparatus according to claim 1, wherein the restraint member includes a first restraint member and a second restraint member,
wherein the first restraint member is fixed to the main assembly,
wherein the second restraint member is movably provided interrelated with movement, between the first position and the second position, of the fixing unit, and
wherein the first restraint member and the second restraint member are apart from each other when the fixing unit is in the first position, and are combined when the fixing unit moves from the first position and reaches the second position, and a restraint force is generated.

3. The image forming apparatus according to claim 2, wherein one of the first restraint member and the second restraint member is a male shape and the other is a female shape, the restraint force is generated by the male shape and the female shape being fitted with each other, and the restraint force is released by a reaction force greater than the restraint force.

4. The image forming apparatus according to claim 2, wherein one of the first restraint member and the second restraint member includes a material having a magnetic force or a structure for generating the magnetic force and the other is a material in which an attractive force is generated by the magnetic force, and the restraint force is generated by directly or indirectly attracting of the first restraint member and the second restraint member, and
wherein the restraint force is released by a reaction force greater than the restraint force.

5. The image forming apparatus according to claim 2, wherein the first restraint member and the second restraint member include a locking portion lockable while being fitted with each other and a releasing portion releasable by the locking portion while being separated from each other, the restraint force is generated by the locking portion, and a lock of the locking portion is released by the releasing portion.

6. The image forming apparatus according to claim 1, further comprising:
an abnormality detecting means configured to detect abnormality of the image forming apparatus and to stop conveyance of the recording material, and
a notifying means configured to notify a process flow in which a retained recording material retained inside the image forming apparatus is removed after the conveyance of the recording material is stopped by the abnormality detecting means and the image forming apparatus is restored to an image formable state,
wherein the process flow notified by the notifying means includes a process flow in which the retained recording material is removed by moving of the fixing unit from the first position to the second position.

7. The image forming apparatus according to claim 6, further comprising:
a length detecting means configured to detect a length of the recording material in the conveyance direction of the recording material, and
a predicting means configured to predict a position of a leading end or a trailing end of the retained recording material based on information on the length in the conveyance direction detected by the length detecting means when the conveyance of the recording material is stopped by the abnormality detecting means,
wherein when the process flow in which the retained recording material is removed by moving of the fixing unit from the first position to the second position is defined as a first process flow and a process flow in which the retained recording material is removed by not moving of the fixing unit from the first position to the second position is defined as a second process flow, the notifying means notify to select either the first process flow or the second process flow based on a result predicted by the predicting means.
